(19) United States
(12) Patent Application Publication
(10) Pub. No.: US 2012/0119491 A1
(43) Pub. Date: May 17, 2012

(54) Hollow Fiber Connection

(76) Inventors: Ulrich Rösch, Urbach (DE); Wladimir Jevdokimov, Koblenz (DE)

(21) Appl. No.: 13/292,331

(22) Filed: Nov. 9, 2011

(30) Foreign Application Priority Data
Nov. 12, 2010 (DE) 102010043877.4-41

(51) Int. Cl. F16L 19/00

(52) U.S. Cl. 285/342; 285/339

(57) ABSTRACT

A hollow fiber connection for the radial sealing connection between a hollow fiber and a connection element and/or between the hollow fiber and a housing, particularly for a device for field flux fractionating. Here, the hollow fiber is arranged in a housing connection of the housing. A sealing of the hollow fiber in reference to the connection element and/or the housing as well as in reference to the environment may be yielded according to the invention such that an annular element and a connection element are coupled via a connection part to the housing and/or the hollow fiber and that the hollow fiber connection achieves a sealing via a section between the hollow fiber and the connection element, which is created by an axial displacement of the annular element in reference to the connection element.

### FIELD

The present invention relates to a hollow fiber connection for an end of a hollow fiber provided for fractionating field flow, comprising a connection element with a penetrating opening for accepting the end of a hollow fiber.

### BACKGROUND

In a device for fractionating field flow, in which a hollow fiber is used, the hollow fiber performs the function of a separating channel and samples of substance mixtures as well as solvents are usually guided to the hollow fiber and/or drained therefrom via a standard connection of high-performance liquid chromatography (HPLC). The hollow fiber is arranged in a tubular housing and/or a cartridge so that the housing and/or the cartridge encompasses the hollow fiber at a radial distance and thus a volume is formed between the exterior of the hollow fiber and the interior of the housing and/or the cartridge.

Here, a so-called cross-flow develops, which e.g., based on pressure created inside the hollow fiber occurs in the form of filtered fluid discharged from the hollow fiber into the housing. The fluid forming the cross-flow may not by contaminated and thus a leak-proof seal of the hollow fiber towards to the environment is required, particularly the exterior jacket area of the hollow fiber.

One difficulty in the sealing of a hollow fiber is finding a compromise between the sealing capacity of the connection and the stress upon the hollow fiber, because hollow fibers show a relatively thin wall thickness and thus they are very fragile. Any sealing at the connection of the hollow fiber towards the housing must be sufficient to safely prevent leakage between the hollow fiber and the housing, however the impacting force may not be too strong so that the interior jacket area of the hollow fiber suffers no excessive cross-sectional constriction and here may break or perhaps tear.

For example, capillary connections may be provided in order to realize this compromise in the best possible fashion. However, this punctually applies a high stress onto the hollow fiber, particularly at its beginning and end sections. Additionally, the constriction of the interior diameter of the fiber caused thereby leads to eddying of the sample during the inflow and outflow. Additionally, this worsens any precise focusing at the inlet side, particularly according to a flow-related placement of the sample at the desired starting point near the wall of the hollow fiber. Disadvantageously fractions already separated at the outlet side are once more eddied at such constructions and the increased band widths and unsymmetrical peaks occur.

### SUMMARY

An objective of the present invention is to provide a connection for a hollow fiber which can ensure a securely sealing connection. Additionally, it is the objective to provide a connection by which a fragile hollow fiber can be fixed with a moderate reduction of its cross-section and thus under moderate stress of the fiber. Further, the objective is to ensure with the connection a reproducible fixation and sealing of the hollow fiber. Last but not least the objective is given to provide a connection in which an excessive constriction of the cross-section of the hollow fiber can be largely excluded.

The above-stated objective can be attained in a hollow fiber connection for an end of a hollow fiber suitable for fractionating a field flow having a connection element, which comprises a penetrating opening to accept the end of the hollow fiber. According to the invention it is suggested to provide an annular element that can be mounted to the connection element, with the annular element and the connection element being designed such that the assembly of the annular element at the connection element leads to a reduction of the cross-section of the penetrating opening in the connection element for a sealing connection of the end of the hollow fiber to a section of the connection element limiting the penetrating opening.

According to embodiments of the invention, the fiber can be sealed via a radial pressure, particularly via a type of clamping pressure and/or clamping force. Here, the cross-section of the fiber may not be excessively altered. As already indicated, here, the difficulty comprises to seal the fragile hollow fiber such that the examined fluid sample cannot enter the cross-flow and the housing and/or the cartridge may not show any leakage towards the outside. Thus, an optimal compromise must be found between the maximum fastening and sealing effect and a minimal reduction of the cross-section.

The thinner or more porous the embodiment of the hollow fiber the more difficult to design the connection or appropriately perform the assembly without excessive numbers of adjuvants or specialty tools. In this context it shall be mentioned that based on the fact that a hollow fiber of the type in question is permeable, i.e. allows liquids and is gas to penetrate, such a hollow fiber may not be mistaken for capillaries or tubular materials in the narrow sense of the word.

In a connection according to the invention a pressure can be applied via a ring and/or annular element, particularly a type of conical pressure ring, upon the connection element, which can be aligned in a targeted fashion to a section in which a radial sealing shall occur. Here the annular element and the connection element can be pressed jointly by a connection part against the end of a housing and/or tubular housing part.

Therefore, using the invention a hollow fiber can be securely sealed such that the force applied upon the fiber from the outside e.g., in the form of a clamping pressure, can be predetermined to the appropriate value. This is particularly advantageous for hollow fibers made from plastic, such as polymers as the carrier material, which must be handled with care, and in which the carrier material may also show a certain porosity, with the hollow fibers may also be embodied from a plastic carrier with an ultra-filtration diaphragm applied at least at the outside. Using the porosity it can be adjusted if and to what extent the hollow fiber is permeable in the radial direction perpendicular in reference to the longitudinal axis of the fiber for a fluid or certain components of the fluid. Another advantage of the invention is considered the fact that any type of adhesives, putty, or other adhesive adjuvants can be omitted, because they or the adjuvants contained therein are released by the eluents required for the measurement and then may damage the detectors.

In the assembled state, the annular element can essentially be pushed, rotated, or placed onto the connection element along the longitudinal axis of the fibers. In the assembled state, the section can essentially be made to contact via its entire perimeter the outside of the end of the hollow fiber, i.e. contact over the entire exterior circumference of the hollow fiber, particularly if it relates to a rotary symmetrical penetrating opening. Further, the annular element may be arranged in reference to the longitudinal axis of the fiber in a position which is essentially central in reference to the is position of the section, i.e. when the annular element is e.g., wider than the section it overlaps in the assembled state the section in both directions along the longitudinal axis of the fiber to an approximately even extent.

According to an exemplary embodiment the hollow fiber connection is embodied such that the forces applied in the assembled state of the annular element upon the connection element are essentially aligned radially in reference to the longitudinal axis of the fiber in the direction towards the end of the hollow fiber. This way, by the sealing connection, the forces acting upon the hollow fiber in the assembled state of the annular element can be essentially aligned in the radial direction. Essentially in the radial direction means that the annular element primarily ensures a sealing connection by way of radial forces. The annular element may also be embodied as a cone-shaped pressure ring or e.g., as a cutting ring made from stainless steel. A pressure ring here acts essentially such that it causes a deformation of the surface upon which it is mounted and a cutting ring can additionally act such that it partially penetrates the surface.

According to an exemplary embodiment the connection element comprises a first section, particularly a section at the side facing the connection in the assembled state, which can be named a radial pressure area and which is embodied to transfer radial pressures to the hollow fiber. Further, the connection element may comprise a second section, particularly a second section facing the housing in the assembled state, which can also be named a positioning section. This way, a connection element can at least perform the two functions sealing the fiber and positioning the connection element in a housing, particularly spatially separated from each other, which is advantageous for the precision of a centering and the sealing of the fiber. Because this way, e.g., radial and axial forces can impact the connection element largely independent from each other. According to the invention, axial forces do not flow here over the first section in which a sealing connection shall be ensured, but they are essentially transferred via the second section.

At the side of the connection means that in the annular element or the connection part or the connection element the side is referred to here which in the assembled state faces away from the building, i.e. away from a fractionating device. At the side of the housing represents the opposite, i.e. it relates to a side of the annular element, connection part, or connection element which points in the assembled state to the housing and/or to a cartridge or a fractionating device.

According to an exemplary embodiment the connection element is embodied at least in the first section with a compressible material, particularly with regards to radial forces. Additionally this material should be less compressible than the material of a hollow fiber to be sealed, however it may not be too soft so that a sealing clamping function can even be fulfilled when the material of the hollow fiber itself is also rather pressure resistant. Thus, the material of the first section may not be too soft in order to allow defining for the hollow fiber, largely independent from the material, to what extent a reduction of the diameter shall occur.

Further, preferably the material shall be largely incompressible and/or non-deformable in reference to axial forces in the direction of the longitudinal axis of the fiber. This way even in case of major torque acting upon the annular element it can be ensured that a hollow fiber is not crimped and/or pressurized in the longitudinal axis of the fiber. The connection element can comprise plastic, at least partially, particularly in the first section.

The connection element can therefore be embodied from a material that can be deformed by radial pressures and further be embodied such that a radial deformation due to an essentially radial force upon the first section essentially has consequences only in said first section and is largely ineffective with regards to the position and alignment of the second section. This effect can additionally or alternatively be achieved, for example, by a certain geometric arrangement of the first section and the second section in reference to each other, with the sections may each comprise specific is wall thicknesses, the first section particularly a higher wall thickness than the second section. Additionally, by the geometric relationship between the annular and/or connection element it can be determined to what extent a hollow fiber shall be constricted in the area or a section of the penetrating opening.

According to an exemplary embodiment the connection element comprises in the first section an intermediate section which in the following is explained in greater detail, and which can be subjected to a flexural load such that during the assembly of the annular element the first section can be deformed in the radial direction, however due to the elasticity and/or flexibility of the intermediate section this deformation is not transferred to the second section. Thus, the second section remains inherently stable regardless of the deformation of the first section.

According to an exemplary embodiment the section limiting the penetrating opening is essentially located entirely within the first section so that a radial deformation in the first section is largely without any effect upon the location and alignment of the second section. This way, the functions of sealing and/or centering the fiber in the connection element and positioning the connection element at a tubular housing part can be ensured separated from each other even when the connection element is assembled with only a single connection part and/or adapter, e.g., braced with a cartridge. The section can further be arranged spatially separated from the second section such that an interim section is provided, with the section no projecting therein.

According to an exemplary embodiment the section limiting the penetrating opening is arranged in the half of the first section facing the connection such that a distinct spatial separation of the functions sealing and positioning can be implemented. Here, at the side of the connection means in the installation position facing the connection part which acts upon the annular element.

According to the invention in the installed position the annular element can be stressed by the connection element with a tension in the radial direction, with the tensile force is causing that the annular element exerts a reaction force in the radial direction in reference to the hollow fiber upon the first section of the connection element.

The connection element may be embodied from a material which is more elastic and/or softer than the material the annual element is made from. This dependency of the material features relates primarily on the stability in the radial direction, because the tensions created in the annular element by being pushed onto the connection element shall lead to a radial deformation of the penetrating opening.

According to an exemplary embodiment the annular element comprises an interior surface at least over a partial section, which conically widens so that an interior cone develops which in the assembly direction and/or in the installation position points to the connection element. In other words, the annular element may be embodied as a cone-shaped press ring with a press surface. The conical interior surface formed this way widens toward the outside and is tilted radially outwardly in reference to an axis of symmetry and/or central axis of the annular element and is provided at the side of the annular element by which the annular element is made to contact the connection element. This way, a pressure can be created focused on the section, i.e. the clamping section and/or sealing section. In order to avoid that the annular element is distorted in reference to the connection element both the annular element at its interior surface as well as the connection element at its exterior surface may show grooves or corrugations, extending for example essentially in the axial direction.

The force exerted by the annular element upon the connection element during the connection of the connection part to form a tubular housing part comprises an axial and a radial component, with the radial component being greater than the axial component so that a force vector develops, which tilts in reference to a level orthogonal in reference to the longitudinal axis of the connection element by only an acute angle, particularly in the range from approximately 5 to 30 degrees, with the value of the radial component over the angle of the interior cone being defined in reference to the longitudinal axis of the annular element. The radial component of the force vector may therefore be is increased by a smaller angle of the interior cone in reference to the axial component.

The annular element and/or the ring can be designed such that the force vector comprising an axial and a radial component is embodied essentially orthogonal in reference to the interior side of the annular element and/or ring and the conical interior surface serving as the press surface. In this case the direction of the force vector is therefore essentially determined by the incline of the conical interior surface, while a part of the press surface in the installed position aligned parallel in reference to the longitudinal axis or the fiber not showing any measurable influence in the direction of the force.

This way, a sealing connection free from adhesives and lubricants can be created, which can act according to the principle of a sloped plane, i.e. the conical angle of the annular element can be embodied in such a form that the pressure exerted upon the fiber via the radial direction and/or the connection element is applied evenly via the contact and/or press surface. This way, any measurable punctual cross-sectional constriction or cutting into a fragile surface of a diaphragm inside the fiber can be effectively avoided.

According to an exemplary embodiment the conical interior surface is tilted at an angle smaller than 45 degrees in reference to a longitudinal axis of the annular element, particularly in an angle ranging from 5 to 30 degrees. The longitudinal axis can also be called the central longitudinal axis extending through the center of the annular element. The central longitudinal axis may represent a symmetry axis of the annular element, particularly in case the annular element is embodied as a rotary symmetrical ring. The ring element may also show any other geometry, in principle, particularly a geometry deviating from the circular form.

The connection element may comprise an exterior bevel, which is arranged at an angle in reference to the longitudinal axis of the connection element essentially equivalent to is the angle of the interior cone of the annular element. The exterior bevel must be provided at the side from which the ring element is to be brought into contact with the connection element and shall contact the contact surface of the connection element. This way, the connection element and the annular element can be coupled to each other in a simple fashion, particularly without any tools or any fastening devices, which facilitates the assembly. The position of the annular element on the connection element can therefore be largely defined in a precise fashion so that any canting during the displacement of the annular element in reference to the connection element can be largely excluded. The annular element can therefore be coupled to the connection element in a simple fashion before a connection part or the like is screwed to the tubular housing part and the annular element is pushed or pressed via the connection part onto the connection element.

The annular element may show an axial length in the direction of the longitudinal axis of the fiber which is greater than the width of a first jacket surface and/or counter pressure surface of the connection element in a first section, with the first jacket surface being equivalent to the connector of the surface and/or surfaces by which the annular element acts upon the connection element and/or which it contacts. This way it can be ensured that a connection part, independent from the type of assembly, cannot come into contact with the connection element. Additionally it can be ensured that the radial force required is actually exerted, thus that the annular element is not positioned at a wrong position on a first jacket surface of the connection element but is actually pushed to the connection element up to a contact surface. Further it can be ensured that the radial pressure can be transferred over the entire axial length and that the first jacket surface no longer widens. This might occur when the annular element was shorter, i.e. less wide than the first jacket surface of the connection element, and this way a pressure applied at this point upon the hollow fiber would be reduced. However, there may be cases in which it is advantageous for the annular element to be embodied less wide than the first jacket surface so that the pressure applied upon the hollow fiber is weaker at the edge region towards the outside, e.g., by a steady, gentle transfer to a section at the penetrating opening and to clamp the hollow fiber in a particularly gentle fashion.

According to an exemplary embodiment in the section limiting the penetrating opening the connection element comprises a bar or a similarly shaped projection defining a first sealing surface which is embodied such that in the assembled state of the annular element a hollow fiber contacts an exterior jacket surface of the connection element in a sealing fashion. Using such a bar and/or a similarly shaped projection a sealing can be implemented in a particularly targeted and effective manner. Additionally, the functions of centering and/or sealing by a bar can be separated from each other in the section, at least partially, e.g., by the first sealing surface primarily fulfilling the sealing function and the remainder of the part of the section contacting the hollow fiber primarily fulfilling the centering and fastening function. Nonetheless, in principle, a hollow fiber can also be centered in the connection element exclusively by the first sealing surface.

The bar can further define the first sealing surface such that it comprises essentially a cylindrical shape, with its roundness deviating by preferably less than 2/100 millimeter from an ideal cylindrical form. The same tolerances may also be given for a second sealing surface, if applicable, which shall contact the hollow fiber.

The bar can be arranged in the axial direction essentially centrally in the first section. The annular element together with the connection element may be designed such that at this point a defined, if applicable maximal pressure is created. Essentially in the center means in this context that the bar is arranged approximately at half the length in reference to the overall length of the first section along the longitudinal axis of the fiber. The bar may also be located slightly to the left of the middle of the first section, thus against the direction of assembly, if this is beneficial for an improved separation of the functions positioning and jamming and/or compressing. At this central position of the bar a maximal pressure can be created by the annular element in the installed position with respect to the section, with the position of maximal pressure may be defined by the width of the first jacket surface of the connector as well as by the width and the angle of the interior cone of the annular element. The position of maximum pressure can here coincide with the location of the bar so that for example, in case of embodying a conical is interior surface at the interior side of the annular element, the pressure created at the transition from the conical interior surface to the pressure surface is aligned to the bar due to a specific angle. If e.g., half of the pressure surface is formed conically, preferably the arrangement can be made such that in the installed position a resulting force vector also acts upon the provided location on the section when the section is arranged in the half of the first section at the connection side. According to the invention the position of the interior cone may be designed depending on the width of the annular element, the length of a first jacket surface of the connection element, as well as the position of the section in order to determine the optimal location for the force to act.

In addition to the bar, in the direction of a connection part, i.e. at the side of the connection, a second sealing surface may be provided, particularly only a second rotary symmetrical sealing surface, which is arranged concentrically in reference to the bar and may comprise an axial length which is greater or equal to the width of the bar and shows a larger interior diameter than the bar. This second sealing surface may e.g., also accept the function of centering and fastening the hollow fiber.

The interior diameter of the bar may be smaller than the interior diameter of the second sealing surface, e.g., in a range from 5 to 20 percent, so that the bar projects from the second sealing surface by approximately 5 to 20 percent.

According to an exemplary embodiment the axial length of the second sealing surface next to the bar is approximately equivalent to twice the width of the bar. This way, at the connection side a gentle and/or moderate transition can be created from the constriction of a fiber in the area of the bar towards the end of the hollow fiber.

The hollow fiber may withstand pressures, as mentioned above, depending on its material but also its porosity so that it is of great importance for a simply managed device for sealing the hollow fiber that pressures are applied to the hollow fiber which are not excessive. This also applies to different types of hollow fibers. This also is presents the problem for a manufacturer to provide a connection that can be used universally, if possible, in which depending on the type of the hollow fiber to be sealed only few modifications are necessary. In a connection according to the invention it is in most cases sufficient that material of the connection element and/or in case of the embodiment of a conical interior surface at the interior side of the annular element the angle of said conical interior surface is adjusted to the features of the hollow fiber, which may reduce the number of variants and/or different connections and facilitate the selection. The annular element and in any case one connection part can here be used in a standard embodiment, potentially optimized with regards to costs.

According to an exemplary embodiment a stop is arranged at an exterior side of the connection element pointing radially outwardly , which serves as a contact for the annular element. The stop, e.g., embodied in the form of a radially projecting protrusion, is formed in the second section. Thus, the first jacket surface of the connector is limited by the stop, which the annular element contacts in the assembled state and/or when the connection part is being connected to the housing. The stop and/or contact serves, among other things, to accept the axial forces exerted by the annular element and it prevents that the annular element is pushed too far onto the connection element.

The stop may also serve to position the connection element in a torque-proof fashion in a housing or the like. The stop may therefore be embodied such that in the assembled position torque acting upon the connection element is transferred into a tubular housing part such that a hollow fiber is not distorted. Thus, via the stop a torque-proof positioning of the connection element can be ensured in a housing. According to an exemplary embodiment the stop represents the part of the connection element with the largest exterior dimensions in the radial direction. The stop may comprise a greater exterior diameter than any diameter of the interior cone of the annular element. This way it can be ensured that an annular element in any case, i.e. regardless of the angle of a conical interior surface, can contact the stop.

is According to the invention it is further suggested to additionally provide a connection part for coupling to a device for fractionating field flux, particularly with inclusion of an annular element according to the invention and a connection element according to the invention. The connection element may be coupled to a tubular housing part, which accepts the hollow fiber and encapsulates it, and ensures sealing by pushing together the annular element and the connection element. For this purpose, the connection part may comprise a penetration, e.g., in the form of a penetrating bore, and in the installed position accept and/or encase both the annular element as well as the connection element in an interior chamber. The connection part is essentially provided to create and transfer axial forces between the housing and the annular element.

In the installed state the connection element may comprise a tubular end at the housing side having an exterior diameter which, in reference to the diameter of the interior jacket surface of the connector, is only slightly greater so that at the housing side the connection element forms a tubular, thin-walled centering connection at the end of the second section. By the tubular end and/or a type of centering device two functions of the connection element can be separated from each other, particularly the function of centering within the housing and the function of torque-proofing. This way, the connection element creates a good connection to the tubular housing part, e.g., also with regards to aspects of fluid mechanics. Here the centering connection may project in the installed state into the volume of the housing.

The forces acting upon the hollow fiber may result, as described above, from deforming the first section of the connection element which is caused by the annular element, with in the installed position the annular element being arranged between the connection part and the connection element, and with the connection part alone acting via the annular element upon the connection element and thus upon the hollow fiber. In the installed position, the annular element can essentially be pressurized by the connection part in the axial direction of the longitudinal axis of the fiber. This means, it is not necessary for a transfer of the radial forces to occur between the connection part and the annular element.

According to the invention it is further suggested to embody the hollow fiber connection such that a sealing connection can be created both between one end of the hollow fiber and the connection element as well as between the connection element and the housing, accepting the hollow fiber, of a device for fractionating field flux with the sealing connection to be created between one end of the hollow fiber and the connection element via the section limiting the penetrating opening using the connection part by way of the annular element being axially displaced in reference to the connection element via radially acting forces, and by a sealing connection between the connection element and the tubular housing part being created via a frontal face of the connection element with the help of axially acting forces.

This way, simply by the assembly of the connection part, two sealing connections can be established, i.e. not only the hollow fiber can be sealed but also a volume (can be created) between the hollow fiber and the housing. In addition to the sealing in the section limiting the penetrating opening a sealing connection can also be established between the connection element and the housing via a tubular end and/or via a frontal face of the connection element. For this purpose, the hollow fiber can be arranged adjacent to the housing, which may comprise an external thread. The hollow fiber may e.g., show a diameter of approximately 1.3 mm and be made from a plastic carrier. The plastic carrier may comprise an ultra-filtration diaphragm applied at the interior and the exterior. The housing may e.g. comprise a high-performance liquid chromatography (HPLC)—standard connector. The housing connection may be embodied as a socket and/or encasing tube with an external thread.

According to an exemplary embodiment the connection part may be embodied as a terminal nut for a screw connection with a tubular housing part, particularly with an internal thread. The terminal nut may be screwed onto or into the tubular housing part, with during the axial displacement of the ring in reference to the connection element either a relative movement occurs between the terminal nut and the annular element or between the annular element and the connection element, depending if the annular element shall or shall not follow the rotary motion of the terminal nut.

According to an exemplary embodiment the respective surfaces of the annular element, the connection element, and the connection part are embodied such that any friction force developing during the assembly between a rear face of the annular element and a contact surface of the connection part is lower than a friction force created between the pressure surface of the annular element and a first jacket surface of the connection element. This way it can be ensured that the annular element is not distorted in reference to the connection element even when a friction force is transferred due to a relative motion of a connection part in reference to the annular element. This way, a canting of the annular element in reference to the connection element can be effectively avoided, here. A surface of the annular element is here considered the rear face of the annular element when a connection part acts upon it, thus the side of the annular element which in the installed state points away from the device and/or the housing.

As mentioned above, the connection part may be embodied such that when being connected to the housing and/or the cartridge a force is exerted in a direction upon the annular element which is aligned at least almost parallel in reference to the longitudinal axis of the hollow fiber. This almost parallel alignment can be ensured such that the connection part must be screwed on first over a certain path onto a thread at the housing connection before it comes into contact with the annular element. This way it can be prevented that the annular element cants with the connection element.

According to the invention, further a fractionating device is provided with at least one hollow fiber connection according to the invention, with the fractionating device accepting the hollow fiber and the hollow fiber at one end or at both ends can be held and/or supported by a hollow fiber connection in a sealing fashion.

### BRIEF DESCRIPTION OF THE DRAWINGS

The following description of the figures explains the invention in greater detail based on an exemplary embodiment. It shows:

FIG. 1 a perspective view of components of a hollow fiber connection according to a preferred embodiment of the invention in an exploded illustration;

FIG. 2 a cross-section of components of the hollow fiber connection of FIG. 1 in an exploded illustration;

FIG. 3 a cross-section of components of the hollow fiber connection of FIG. 1 in the assembled state;

FIG. 4 a perspective view of components of a hollow fiber connection as a detail of FIG. 1, with a connection element and a housing connection being modified in reference to the connection element and the housing connection of FIG. 1;

FIG. 5 a cross-section of an annular element and a connection element according to a preferred embodiment of the invention in an exploded illustration;

FIG. 6 a cross-section of an annular element and the connection element of FIG. 3 in an assembled state; and

FIG. 7 a perspective side view of two hollow fiber connections to a cartridge, with one hollow fiber connection according to the preferred embodiment being shown in the assembled state and the other hollow fiber connection in the exploded state.

### DETAILED DESCRIPTION

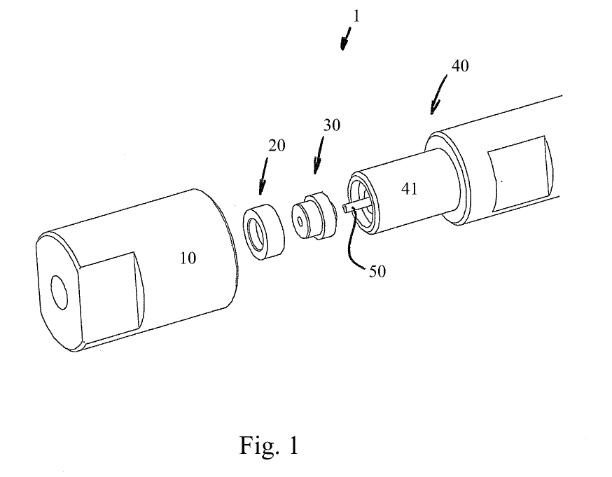

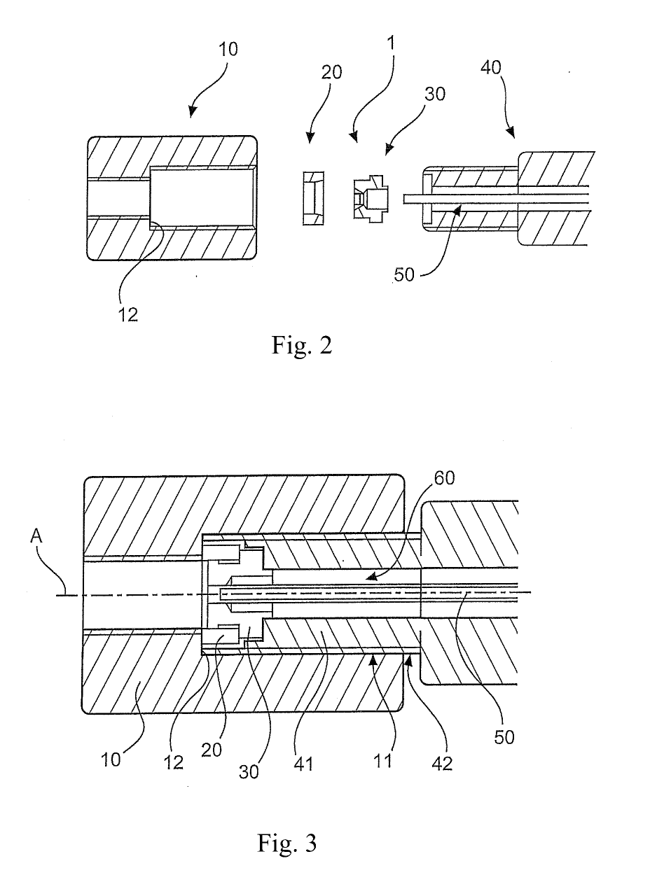

In FIGS. 1 and 2 a hollow fiber connection 1 is discernible with an annular element 20 and a connection element 30, and further a connection part 10 is shown, which can be coupled with one end of a tubular housing part 40 in order to fasten a hollow fiber 50 inside the tubular housing part 40 and positioning it in a sealing fashion. The tubular housing part 40 forms a cartridge, particularly like an exterior tube, in order to support a hollow fiber 50 positioned therein in a sealing fashion. The connection part 10 is embodied as a type of sheath with a penetrating bore and comprises a radial surface 12 at an interior stop, by which during the assembly of the hollow fiber connection 1 it comes into contact with the neighboring face of the annular element 20. FIG. 3 further shows that the connection part 10 may comprise an internal thread 11, so that it can be screwed onto an external thread 42 of a housing connection 41 at the tubular housing part 40 according to the exterior tube. Here, the annular element 20 is driven in the direction along the longitudinal axis A of the fiber onto the connection element 30. In the installed position the connection part 10 here overlaps, as shown, a considerable portion of the housing connection 41 and the connection element 30 as well as the annular element 20. This way it can be ensured that the connection part 10 is aligned essentially coaxially in reference to the longitudinal axis A of the fiber and acts axially upon the annular element 20. This effective direction upon the annular element 20 is indicated in FIG. 5 by the axial arrows B, and radially aligned arrows C indicate in which direction a force can be applied upon a first jacket surface 33a of the connection element 30.

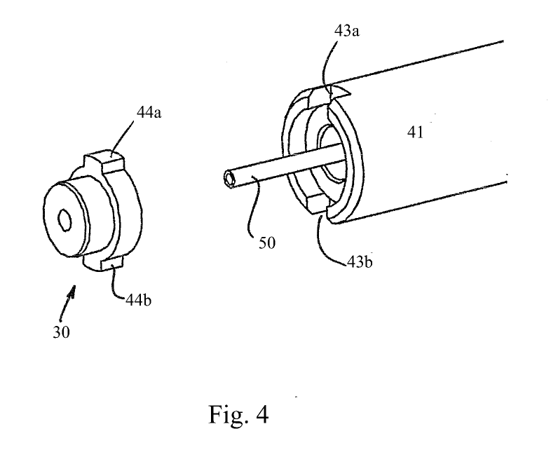

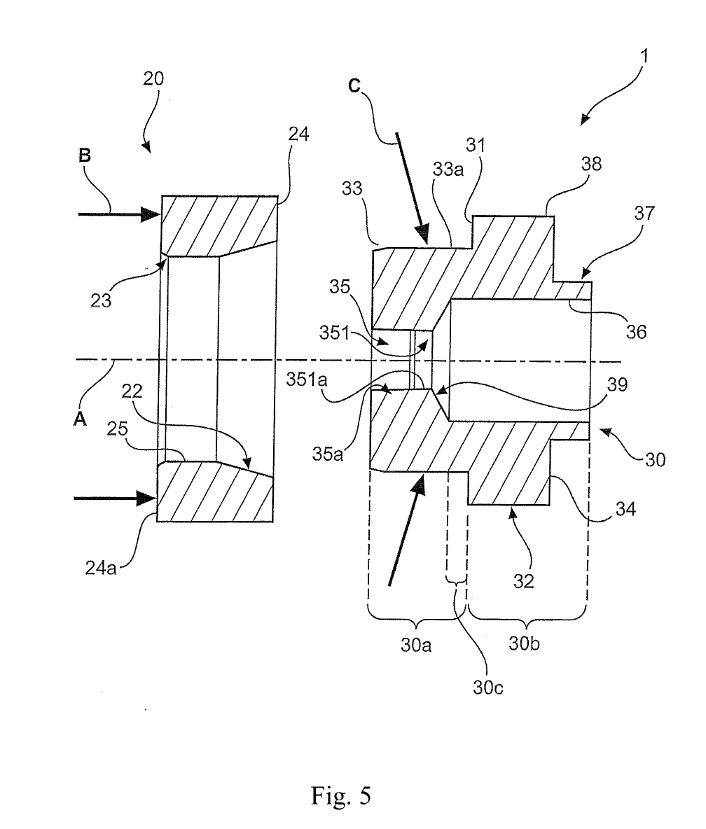

In a modification in reference to the embodiment shown in FIG. 1, in FIG. 4 the cylindrical housing connection 41 of the tubular housing part 40 is embodied at its face with two recesses 43a, 43b, located diametrically opposite each other, and the annular connection element 30 is shown with two projections 44a, 44b, protruding at its peripheral surface radially outwardly and located diametrically opposite each other. The projections 44a, 44b form latching cams for engaging the recesses 43a, 43b at the face of the housing connection 41, which show a form complementary to the projections 44a, 44b. The recesses 43a, 43b at the housing connection 44 and the projections 44a, 44b at the exterior of the connection element 30 therefore jointly form a fixation means for a torque-proof connection of the connection element 34 to the housing connection 41. This way, when screwing the connection part 10 onto the housing connection 41 a transfer is prevented of the rotary motion via the annular element 20 to the connection element 30. The embodiment of the recesses 43a, 34b at the housing connection 41 and the projections 44a, 44b at the connection element 30 is possible in a particularly simple fashion with the help of an injection molding production process, which is recommended additionally for reasons of costs for the production of the tubular housing part 40, the components required for the hollow fiber connection 1, and thus also the overall arrangement and/or the cartridge as a single-use item. Due to a transfer of the rotary motion via the connection element 30 to the hollow fiber 50, in disadvantageous cases, the hollow fiber 50 may be subjected to torque, with here a damage of the sensitive diaphragm coating on the hollow fiber 50 could no longer be excluded.

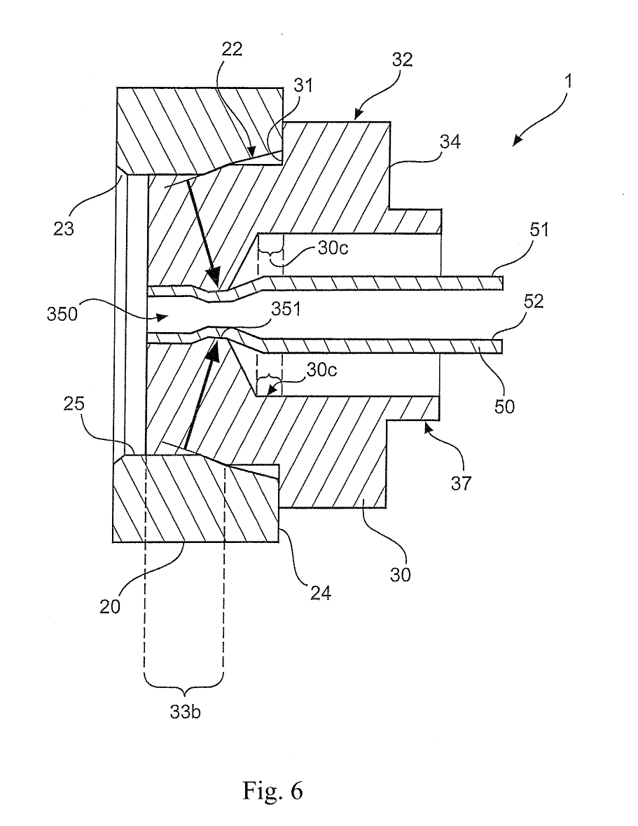

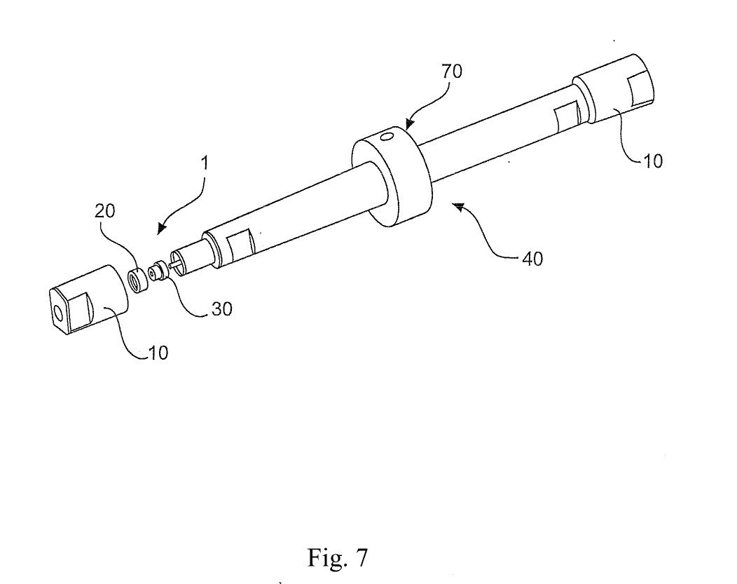

FIG. 5 further shows a pressure surface 25 and an interior cone 22 at the annular element 20, and at the connection element 30 a penetrating opening 350 is discernible, which is defined by a section 35 and in which a hollow fiber (cf. FIG. 3) can be held in a sealing fashion. The connection element 30 further comprises a stop 32 with a contact surface 31, which the annular element 20 can contact in the installed position and/or can be made to contact as shown in FIG. 6. The annular element 20 contacts the stop 32 and overlaps the connection element 30 at the side at which in the installed position the connection part 10 (cf. FIG. 3) is provided. The hollow fiber 50 is fastened in the penetrating opening 350 and/or held in a clamped fashion and is here slightly compressed by the bar 351, namely to a considerably amount.

In the following, with a detailed reference to the FIGS. 1 through 6, the functions and effectiveness of the hollow fiber connection 1 is described.

Firstly it must be mentioned that via the connection part 10 an axial clamping of the annular element 20 and the connection element 30 can occur via the tubular housing part 40, with the axial force flux applied by the connection part 10, essentially aligned along the longitudinal axis A of the fiber, is transferred via the annular element 20 and the connection element 30 into the external thread 42 of the tubular housing part 40, so that a closed line of force develops between the contact surface 12 and the external thread 42: the annular element 20 and the connection element 30 are subjected to pressure, and the connection part 10 is essentially subjected to tensile stress, particularly in the area overlapping the housing connection 41. This way, an axial force can be applied via the connection part 10 and the annular element 20 to the connection element 30 and a force flux is given between the contact surface 12 of the connection part 10 and the external thread 42 at the housing connection 41, which in the axial direction extends over the annular element 20 and the connection element 30. This way, in an appropriately stable design of the annular element 20 and the connection element 30 a strong axial force can be transferred and a secure sealing connection can be created, particularly also at an interface between the connection element 30 and the housing connection 41, either essentially via a tubular end 37 and/or via a frontal face 34 of the connection element 30, as shown in FIG. 5 or 6. Here, the axial force can be transferred most directly via the frontal face 34. However, it is also possible to implement both the jacket surface of the tubular end 37 as well as the frontal face 34 and/or the respective contact areas at the tubular housing part 40 with a surface, via which a sealing effect can be achieved so that a volume 60 between the hollow fiber 50 and the tubular housing part 40 can be sealed from the environment. The volume 60 is also partially formed by the connection element 30, particularly via an internal jacket surface 36 as shown in FIGS. 3 and 5. Additionally, the jacket surface of the tubular end 37 and/or the respective contact surface at the tubular housing part 40 may be embodied slightly conical so that a press fit can also be implemented depending on the axial forces applied.

In order to explain the function sealing a hollow fiber 50 first it shall be mentioned that a hollow fiber connection 1 according to the invention, in spite of the chance of a strong axial torque, can ensure a gentle and finely adjustable fastening and sealing of the hollow fiber 50. Here, it shows that in the preferred embodiment of the connection element 30 shown the function of a radial sealing and fastening of the hollow fiber 50 can be separated from the function of an axial sealing of the connection element 30 in reference to the tubular housing part. For this purpose, in the exemplary embodiment shown a first section 30a is provided spatially separated from a second section 30b, and as a transition between these sections an interim section 30c may be provided, which is encompassed by the first section 30a. In the first section 30a primarily radial pressures are created and transferred to the hollow fiber 50, with the hollow fiber 50 perhaps being radially constricted to a predetermined extent, as shown in FIG. 6.

The hollow fiber is fixed and sealed with its exterior jacket surface 51 in a section 35 in the penetrating opening 350, particularly via a first sealing surface 351a at the bar 351 and also via a second sealing surface 35a. The radial pressure is caused by the annular element 20 and guided along a compressed section 33b starting from the first jacket surface 33a to the section 35, particularly also to the bar 351. During the assembly, the annular element 20 can first be coupled via the interior cone 22 to the connection element 30 and first contact an exterior bevel 33 at the connection element 30. In order to bring the annular element 20 into the assembled position, an axial force is applied via the connection part 10 to the rear face 24a of the annular element 20 until the annular element 20 impinges the stop 32, thus contacts with a front face 24 the annular element 20 at the contact surface 31. In the assembled state, by the geometry of the annular element 20 and the position of the stop 32, here the compressed section 33b develops, by which a radial force can be applied aligned to the section 35. In FIG. 6 the compressed section 33b is discernible at the connection element 30, by which the annular element 20 acts both with a part of the interior cone 22 as well as a part of the parallel extending press surface 25 upon the first jacket surface 33a of the connector 30.

In the following, in a chronological sequence, detailed explanations follow concerning the FIGS. 5 and 6. The forces acting during compression are indicated by the respective arrows. In particular, the axial arrows B are indicated at the annular element 20, showing a force that can be created by a connection part (cf. FIG. 2) and the radially aligned arrows C at the connection element 30, which indicate a force acting by the annular element 20 upon the connection element 30.

FIG. 5 shows a preferred exemplary embodiment of the hollow fiber connection 1 with the annular element 20 and the connection element 30, with at the annular element 20 the force essentially acts in the direction of the longitudinal axis A of the fiber and at the connection element 30 the force applied via the annular element 20 acts also slightly in the direction of the longitudinal axis A of the fiber, but primarily in the radial direction, thus almost orthogonally in reference to the longitudinal axis A of the fiber. At the annular element 20 the front face 24 is discernible, which is provided to contact to the connector 30 via the contact surface 31. Via this interface high axial forces can be transmitted from the connection part 10 to the housing connector 41 (cf. FIG. 3) so that also a sealing connection can be ensured between the connection element 30 and a housing. The axial forces are transferred into the annular element 20 via the rear face 24a, particularly via a contact surface of a connection part. The annular element 20 further comprises the press surface 25, which transfers into the interior cone 22 and/or comprises it. The interior cone 22 is radially tilted towards the outside, i.e. in reference to the longitudinal axis A of the fiber it comprises an acute angle ranging from approx. 5 to 35 or up to 40° in the direction of the connector 30. As shown, the interior cone 22 extends over approximately half of the width of the ring 20, and the other half is formed by a surface, essentially aligned parallel in reference to the longitudinal axis A of the fiber and/or an axis of symmetry of the annular element 20, forming a part of the press surface 25. The press surface 25 transfers via a bevel 23 into the rear face 24a. The bevel 23 may serve, e.g., to provide a burr-free edge at the interface to a connection part so that in case of a potential relative motion between a connection part and the annular element 20 no high friction forces develop.

As already mentioned, the connection element 30 comprises two sections with independent functions each, on the one hand the first section or press area 30a and on the other hand the second section 30b. The sections 30a, 30b, can here be separated, visually speaking, via the contact surface 31, with the press surface 30a being provided to transfer forces applied by the annular element 20 via the section 35 to a fiber (not shown). In the press section 30a the section 35 limiting the penetrating opening 350 is arranged in the form of a circumferential wall, as shown essentially in the half of the press section 30a, facing away from the stop 32, with the section 35 comprising the bar 351, at which a first sealing surface 351a can essentially perform the sealing and fastening function of a fiber.

Further, a second sealing surface 35a is embodied at the section 35 limiting the penetrating opening 350, which as shown comprises greater interior diameters in reference to the bar 351. This way, the bar 351 can apply, if applicable, a greater force or at least a higher pressure upon the hollow fiber 50 than the second sealing surface 35a, however the second sealing surface 35a can additionally ensure, e.g., the function of centering. At the side of the press section 30a facing the annular element 20 the exterior bevel 33 is provided, which may comprise the same angle in reference to the longitudinal axis A of the fiber as the interior cone 22 of the ring so that an assembly of the ring 20 on the connection element 30 is easily possible. In particular the annular element 20 can be plugged onto the connection element, thanks to the external bevel 33, and here be easily positioned without any fastener, before it is pushed and/or pressed entirely by any connection part onto the connection element 30. The exterior bevel 33 is particularly advantageous when an alignment of a connection part is ensured in reference to a tubular housing part such that the connection part is screwed over a certain distance only onto a thread at a housing connection, before it comes into contact with the annular element 20. This way, via the bevel 33 any canting of the annular element 20 can be prevented, even when the annular element 20 is briefly no longer accessible before it is pushed on.

The connection element 30 further comprises the second jacket surface 38 at the stop 32, by which a radial torque-proofing of the connector 30 can be ensured in any housing. This torque-proofing can occur, e.g., via a particularly rough surface of the second jacket surface 38 in connection with a press fit in a housing, however a form-fitting connection may also be given, particularly when the stop 32 is not embodied cylindrically but shows a geared or otherwise structured secondary jacket surface 38. The second jacket surface 38 transfers via the frontal face 34 of the connection element 30 into the tubular end 37, by which the connection element 30 can be centered in a tubular housing part and/or a device. Due to the fact that it shows only slightly smaller interior diameters than the exterior diameters of the tubular end 37, the interior jacket surface 36 forms with the tubular end 37 a rather thin-walled connection piece, compared to other wall thicknesses of the connection element 30.

The interior jacket surface 36 transfers into the bar 351 via an interior bevel transfer 39, is which is arranged as already shown in the press section 30a. This interior bevel transfer 39 may also be design-related, however it may also be given a function such that its angle and/or its length has consequences if and/or how strong the radial forces applied in the press section 30a shall or shall not be transferred upon the second section 30b. As shown, the interior bevel transfer 39 is relatively steep, i.e. greater than 45° in reference to the longitudinal axis A of the fiber, and it ends at a position in the press section 30a, which shows a certain minimum distance from the stop 32 and/or the contact surface 31 so that here also a separation of the press section 30a from the second section 30b can occur due to the wall thicknesses and the positions and geometric conditions. The section between the interior bevel transfer 39 and the stop 32 is here marked as the interim section 30c, which shows only minor flexural stiffness however high pressure resistance. When an interim section 30c is provided, the first section 30a may also be considered a section which laterally follows the interim section 30c, thus not encompassing it. Because an interim section 30c is provided for the purpose of primarily transferring bending forces, not radial pressures.

As further discernible in FIG. 5, the interim section 30c is already in contact with the section of the interior jacket surface 36 and represents the section and/or part of the first section 30a, which shows the smallest wall thickness. In such an embodiment of the geometric conditions a pressure applied upon the first jacket surface 33a of the connection element 30 can be particularly effectively transferred to the section 35 without any deformation in the first section 30a being noticeably transferred to the second jacket surface 38 of the second section 30b. This is then also largely independent from the materials selected for the connection element 30.

FIG. 6 shows the components of FIG. 5 in the assembled state. The hollow fiber connection 1 is now shown in connection with the hollow fiber 50, and it is discernible how a force applied from the annular element 20 upon the connection element 30 influences the hollow fiber 50. The hollow fiber 50 is held with its exterior jacket surface 51 within the penetrating opening 350 in the press area and/or section of the connector 30. Based on the incline and/or angular position of the interior cone 22 at the annular element 20, in connection with the length of the interior cone 22 and/or the width of the ring 20, the effective point of force can be aligned to the position of the bar, particularly depending on the position of the ring 20 on the connection element 30. This is indicated by respective arrows in the direction of the influence of force. However, the cross-section of the hollow fiber 50 is influenced by the bar 351 but also by the second sealing surface, both at its exterior jacket surface 51 as well as its interior jacket surface 52, in the present case it is compressed. The reduction of the cross-section of the hollow fiber 50 is here most important at the location of the bar 351, thus at the position to which the force vectors are aligned. A radial force can be transferred over the entire range of the penetrating opening 350. In the assembled state the annular element 20 with its front face 24 contacts the contact surface 31 of the stop 32. Here, the annular element 20 overlaps the connection element 30 at the opposite side. This way a force can be applied homogenously upon the connection element 30 over a wide range of the press section 30a and simultaneously a force flux can be focused to the bar depending on the angle of the interior cone 22.

For the purpose of cross-sectional constriction of the interior diameter of the sealing surfaces 35a, 351a of the connection element 30, the bar 351 is arranged at a point with a defined, if applicable maximum pressure. This bar 351 can seal the fiber 50 by the above-mentioned impact of force against a pressure of up to 30 bar. Simultaneously any displacement of the fiber 50 within the connection element 30 can be prevented in the axial direction. By the force, applied evenly from the outside, the fiber 50 is coaxially supported in reference to all other parts of the housing 40 and/or the cartridge. The precise concentricity of the fiber 50 is of high importance, because it is known that rotary symmetry is only poorly achieved or not at all when only a poor separation is given. Because in these cases there is the risk that any off-set of the fiber 50 in reference to the supply lines is given, so that any turbulences occurring worsen the focusing/relaxation of the sample at the inlet and additionally any already separated fractions are mixed at the outlet.

FIG. 7 shows the hollow fiber connection 1 in connection with the tubular housing 40 as well as two connection parts 10, with one connection pat 10 in the already assembled state and the other connection part 10 in the exploded illustration together with the annular element 20 and the connection element 30. The housing 40 shown may represent e.g., a part of a fractionating device. In connection with the FIGS. 2 and 3 it is discernible that the hollow fiber 50 shows a considerably smaller diameter than the housing 40 so that a volume 60 and/or a radial volume results therebetween in which a lateral flow develops, which is drained via a collar-shaped connection 70. In order to adjust to different applications the length of the cartridge 40 can be adjusted in a simple fashion.

The annular element 20, the connection element 30, and the hollow fiber are connected to each other after the complete tightening of the connection part 10 such that they cannot be easily separated from each other. If it becomes necessary, though, it is advantageous for the annular element 20 to show a greater radial extension than the connection element 30 so that the annular element 20 can be pulled off the connection element 30 using an appropriate tool, which engages at the frontal face 24. A complete cartridge 40 may comprise two similar connections at the inlet and/or the outlet side of the housing connection. When both connections have been closed and thus the hollow fiber is pressed into the respective connection element 30 the hollow fiber can usually no longer be dismantled, at least not without any destructions.

The connection according to the invention to connect a hollow fiber 50 to a tubular housing part 40 has proven suitable for various diameters of fibers. In case of adjustments of the diameters of the bores it is advantageous to maintain narrow tolerance limits, because a deviation in a range of as little as 2/100 millimeters may reduce the sealing effect. In case in an application the space for the lateral flow between the fiber 50 and the housing 40 is very large, equivalent to a part of the volume 60, a filling of the volume 60 may occur with fine glass or plastic balls, e.g., showing a diameter of approximately 0.5 mm. The lateral flow connector 70 at the cartridge 40 may be embodied as a standard connector.

### LIST OF REFERENCE CHARACTERS

10 Hollow fiber connection
11 Connection part
12 Connection part—internal thread
10 Contact surface
21 Annular element
22 Interior cone
23 Interior bevel
24 Frontal face of the annular element
24a Rear face of the annular element
25 Press surface
30 Connection element
30a First section
30b Second section
30c Interim section
31 Contact surface
32 Stop
33 Exterior bevel
33a First jacket surface of the connector
33b Compressed section
34 Frontal face of the connection element
34 Section
350 Penetrating opening
35a Second sealing surface
351 Bar
351a First sealing surface
36 Interior jacket surface of the connector
37 Tubular end
38 Second jacket surface of the connector
39 Interior bevel transfer
40 Tubular housing part
41 Housing connection
42 External thread
43a, 43b Recess
44a, 44b Projection
50 Fiber
51 Exterior jacket surface of the hollow fiber
52 Interior jacket surface of the hollow fiber
60 Volume
70 Collar-shaped connection
A Longitudinal axis of the fiber
B Axial arrows
C Radially aligned arrows

What is claimed is:

1. A hollow fiber connection for an end of a hollow fiber suitable for field flux fractionating, with a connection element comprising a penetrating opening to accept one end of the hollow fiber, characterized in an annular element that can be assembled at a connection element, with the annular element and the connection element being embodied such that the assembly of the annular element at the connection element leads to a reduction of the cross-section of the penetrating opening in the connection element for a sealing connection of the end of the hollow fiber with the section of the connection element limiting the penetrating opening.

2. The hollow fiber connection according to claim 1, wherein the annular element in the assembled state is arranged essentially pushed onto the connection element in the longitudinal axis (A) of the fiber.

3. The hollow fiber connection according to claim 1, wherein the forces acting in the assembled state of the annular element upon the connection element are aligned essentially radially in reference to the longitudinal axis (A) of the fiber in the direction towards the end of the hollow fiber.

4. The hollow fiber connection according to claim 1, wherein the connection element comprises a first section which is embodied to transfer radial pressures to the hollow fiber.

5. The hollow fiber connection according to claim 4, wherein the connection element is made from a compressible material, at least in the first section.

6. The hollow fiber connection according to claim 4, wherein the first section is made from a material which is largely incompressible in reference to axial forces in the direction of the longitudinal axis (A) of the fiber.

7. The hollow fiber connection according to claim 4, wherein the section limiting the penetrating opening is essentially contained entirely in the first section.

8. The hollow fiber connection according to claim 1, wherein the annular element comprises an interior surface which is formed conically expanded at least in a section so that an interior cone is formed.

9. The hollow fiber connection according to claim 8, wherein the interior surface of the interior cone is inclined at an angle smaller than 45 degrees in reference to the longitudinal axis of the annular element.

10. The hollow fiber connection according to claim 1, wherein the annular element comprises an axial length in the direction of the longitudinal axis (A) of the fiber which is greater than the axial length of a first jacket surface of the connection element in the first section.

11. The hollow fiber connection according to claim 1, wherein the connection element comprises at the section limiting the penetrating opening a bar projecting inwardly, which defines a first sealing surface embodied such that in the assembled state of the annular element it comes to a sealing contact at the connection element at an exterior jacket surface of a hollow fiber.

12. The hollow fiber connection according to claim 11, wherein the first sealing surface shows an essentially cylindrical form, with its roundness preferably deviating from an ideal cylindrical form by less than 2/100 millimeters.

13. The hollow fiber connection according to claim 12, wherein the bar, seen in the axial direction, is arranged essentially centrally in the first section.

14. The hollow fiber connection according to claim 1, further comprising a stop arranged at an exterior side of the connection element, serving as a stop for the annular element.

15. The hollow fiber connection according to claim 1, further comprising a connection part provided for coupling with a tubular housing part surrounding the hollow fiber under inclusion of the annular element as well as the connection element.

16. The hollow fiber connection according to claim 15, wherein the hollow fiber connection is embodied to produce a sealing connection between one end of the hollow fiber and the connection element as well as between the connection element and the tubular housing part accepting the hollow fiber by creating a sealing connection between one end of the hollow fiber and the connection element via the section limiting the penetrating opening via the connection part by way of axially displacing the annular element in reference to the connection element via radially acting forces and by a sealing connection being created between the connection element and the tubular housing part via the frontal face of the connection element.

17. The hollow fiber connection according to claim 16, wherein the connection part is embodied as a terminal nut for a screw connection with the tubular housing part.
